(19) United States
(12) Patent Application Publication
(10) Pub. No.: US 2022/0237984 A1
(43) Pub. Date: Jul. 28, 2022

(54) CONTROL ARRANGEMENT FOR GAMBLERS

(71) Applicant: CUTTING EDGE INNOVATIONS PTY LTD, Bohle Plains, Queensland (AU)

(72) Inventors: Samuel John BROOKS, Bohle Plains (AU); Stephen Matthew HALL, Bohle Plains (AU)

(21) Appl. No.: 17/616,601

(22) PCT Filed: Jun. 3, 2020
(86) PCT No.: PCT/AU2020/050560

§ 371 Date: Dec. 3, 2021

(30) Foreign Application Priority Data
Jun. 4, 2019 (AU) 2019901936

(51) Int. Cl. G07F 17/32; G06Q 30/02; G06Q 50/34

(52) U.S. Cl. CPC G07F 17/3239; G07F 17/3288; G07F 17/3255; G06Q 50/34; G06Q 30/0207; G06Q 30/0271; G07F 17/3269

(57) ABSTRACT

The invention relates to a control arrangement for an application “app” for gamblers, the control including a number of steps. The steps included may include a) identification of a potential member through data input into the app b) verification of the identified user identity, c) registration as a member of the identified and verified user; and d) application for a membership level. The control arrangement membership level limits the periodic spend on gambling and the verified member is incentivised by membership rewards and or betting rewards. The invention also relates to variant methods thereon.

### FIELD OF THE INVENTION

The present invention relates to a control arrangement for gamblers, and in particular to a control arrangement for gamblers to limit financial contribution by the gambler.

### BACKGROUND OF THE INVENTION

Gambling is a fun activity for most people, when undertaken from time to time as an amusement. Examples include a national lottery, national or international sports event, horse racing, motorsport or football match. There is no problem with the occasional gamble or “flutter” for most people. However, the easy, 24 hour, access of betting applications (“apps”) and online betting sites has led to a significant increase in problem gambling. Serious problem gambling is an addiction or compulsion, which is as difficult to quit as a drug or alcohol addiction; professional help will be needed to beat the addiction in the long term. Most gamblers are not strictly addicts, but also are not only an occasional gambler; most gamblers fall into a middle category of gambling rather more money than they can afford. The financial spend each week or month may lead to a slight loss, or may be a serious loss where a person is unable to pay their living expenses as all their wages go towards the gambling. The balance is different person to person, but where a family has an average or low income, the redirection of the funds away from living expenses to the gambling is a serious problem. Money can be redirected away from things the family need for food or bills, to the gambling. A ban on gambling has been attempted in some jurisdictions, but with the internet access, it is unrealistic to completely prevent access to betting websites. Therefore, the banning of gambling in most countries is unrealistic, and so instead some controls are attempted. These controls are generally limited to inclusion of a minimum age requirement to participate, so children are protected from forming gambling habits early.

To date only limited controls have been possible on the amount of spending of a gambler, there has been no real check on a daily, weekly or other periodic spend. The decision on the amount of spend has not been considered, and the person can simply choose to bet as and when they wish. No consideration has been made of what a person can afford, such as the value of the bet, relative to a wage earned. The subject invention allows a member to register for a pre-set financial gambling value, through a particular level of membership. Once set, the pre-set financial gambling value cannot be increased unless particular, also pre-set criteria are met. It is anticipated that these controls can be set, to a particular membership level, so that a person cannot change their periodic spend and cannot keep topping up their account, once a predetermined limit has been reached. In this way the person is prevented from overspending on gambling, they must keep within their monthly membership spend limit. Increases to the limits may be allowable if the person can show they are financially well able to spend some more and they have gambled responsibly within the meaning of the setup for a time. It is envisaged that the invention will be used to access one or more existing betting apps of company websites so that the usage of that known betting product is controlled and strong protections in place for the user. In other forms of use of the invention, the gambling control provides the on-line betting itself. In any of the forms of the invention there is strong protection for the gambler, to protect their finances to a spend within their means, and to act as a stop to potential problem gambling.

Included within the system, are clever inducements to encourage gamblers to use the control system, and likewise to give advertising revenue to the betting company. It is intended that the safety system provides benefit to both the user and the betting companies, and as such should be universally adopted. The inducements to the user include ways to earn points (known in the given examples as “SBUCKS”) to spend on gambling such as by watching advertisements or information videos which may be about gambling or other things. An interaction with the advertiser, leading to free trial sign up, or discount for newsletter sign up are included for additional points and bonuses. Earning some additional points to spend on gambling without additional financial input encourages membership and allows support and education of gamblers, in a beneficial manner. The arrangement allows strong controls for the gambler to keep their spending on this recreational activity within sensible limits. Also, the arrangement allows additional SBUCKs or points to be earned through watching and interacting with advertising, providing additional advertiser revenue to the betting company, as the advertiser will pay to have the captive and willing audience. The information sought at sign up about the members provides tailored advertising with a high likelihood of follow through to sales. Modern targeted advertising assists both the advertiser, to advertise to a likely interested audience, but also directs potentially interesting adverts to the member. The additional funds from the advertising can be used to support the control program, including information provided for healthy betting. Further, the additional funds can also be used for the members to provide a fun and rewarding way to earn additional bets, discounts or prizes, as described in the examples below.

The result of the invention is protection for the gambler to keep their betting within a set value through a complex system of steps. Monitoring for known behaviours by machines and people enables an early intervention for people who would otherwise develop financially crippling problem gambling. An additional benefit is the increased revenue for the control manager and or betting company, and for the members, product discounts, prizes, or free bets.

The invention is a surprisingly clever means to protect against problem gambling, but also a means to produce the financial result of increased advertising revenue for the betting company, and the practical result of prizes and vouchers for the members. It is anticipated that the invention will wholeheartedly be embraced by the various stakeholders, due to the controls against problem gambling, and the mutual benefits.

For clarity, any prior art referred to herein, does not constitute an admission that the prior art forms part of the common general knowledge, in Australia or elsewhere.

It is an object of the present invention to provide a control arrangement for gamblers that at least ameliorates one or more of the aforementioned problems of the prior art. It is a further and separate object of the present invention to provide a method of use of a control arrangement for gamblers that at least ameliorates one or more of the aforementioned problems of the prior art.

### DISCLOSURE OF THE INVENTION

Accordingly, the invention provides a control arrangement for an application “app” for gamblers, the control arrangement including the following steps:
a) identification of a potential member through data input into the app;
b) verification of the identified user identity;
c) registration as a member of the identified and verified user; and
d) application for a membership level,
   wherein the membership level limits the periodic spend and the verified member is incentivised by membership rewards and or betting rewards.

Accordingly, the invention also provides, a control arrangement for an application “app” for gamblers the control arrangement including the following steps:
a) identification of a potential member through data input into the app;
b) verification of the identified user identity;
c) registration as a member of the identified user; and
d) application for a membership level based on a set financial contribution,
   wherein an identified and verified user is able to bet through use of the app only to the financial contribution as denoted by the membership level and the verified member is incentivised by membership rewards and or betting rewards.

Accordingly, the invention provides in a further variant, a control arrangement for an application “app” for gamblers the control arrangement including the following steps:
a) identification of a potential member through data input into the app;
b) verification of the identified user identity;
c) registration as a member of the identified user; and
d) application for a membership level based on a financial contribution after a finance and or credit check to ascertain that the identified user is financially able to comfortably spend of the membership level,
   wherein an identified and verified user is able to bet through use of the app only to the financial contribution as denoted by the membership level and the verified member is incentivised by membership rewards and or betting rewards.

Accordingly, the invention also provides in an exemplary form a control arrangement for an application “app” for gamblers, the control arrangement including the following steps:
a) identification of a potential member through data input into the app;
b) verification of the identified user identity, and there are a series of steps as part of the verification process, including external steps, including identity verification, and may include credit, employment and financial solvency checks;
c) registration as a member of the identified and verified user the registration including information gathering used to tailor advertising to the member and the tailored advertising adds value to the advertiser as they can target the adverts made available to a certain member, and in return the member increases the value of their bets available (betting rewards) and or may get rewards through their membership (membership awards); and
d) application for a membership level,
   wherein the membership level limits the periodic spend, and the verified member is incentivised by the membership rewards and or betting rewards, and further wherein there is no mechanism to increase funds available for betting outside of upgrading the membership level, or the betting rewards.

The control arrangement preferably includes a number of vigorous verification steps, to verify the identity of a user. The steps may check any suitable criteria. The steps may include checks that the identified user can afford to bet and the spend that the person can comfortably afford. Preferably, the arrangement includes checks to verify the person can afford to bet at a particular membership level. A previously identified problem gambler may be flagged on the system by verification and in this case registration will not be permitted to protect the gambler from further gambling. Preferably, use of the control arrangement links to one or more external credit checking agency. Preferably, the control arrangement links to one or more external database to verify information about the user. The information may be chosen from the group: name; age; date; of birth; address; nationality; employment status; employment history; benefit claim status; benefit history; marital status; whether they have dependents; credit check; debt or other checks outside of the credit check; accounts with gambling institutions; verification of payment; and verification of ownership of payment means. Any suitable checks can be included in relation to the suitability of the person for registration.

Preferably, a time delay is incorporated into the verification step to enable intervention action for potentially problem gamblers. Prior art systems allow instant registration, and provided you have a credit card, a funds deposit can be made instantly and betting started within a few minutes. In these prior art systems no check takes place that you are using a real name or that the credit card used is yours. The subject invention works differently, to put separate checks to the identity, and to a verified payment method. Preferably, a verification of identity and a verification of payment means is included.

Preferably, the membership level limits the periodic spend to a set spend suitable for the member, and the membership level and spend cannot be increased without meeting certain conditions. Preferably, the arrangement includes a time delay between a request to increase the membership level or spend, and the change to membership level occurring. The time delay is a sensible precaution, and can include various checks to ensure the person is not some one who should be prevented from being registered. The membership level to set and control the spend may be replaced with any suitable means to define the spend.

Most preferably, the control arrangement will prevent a person from using the app unless they can afford to spend money on gambling, or afford to spend within a set limit. Most preferably, checks to income and gambling history can be used to only permit a person to gamble if they can afford to do so and do not have a history of problem gambling. Preferably, use of the control app provides a safe guard to a member to limit the spend per month or per year on gambling to a figure that they can comfortably afford. Most preferably, there is no mechanism to increase funds available for betting outside of upgrading the membership level. Most preferably, the amount of spend, dictates a number of points, and the points can be spent on gambling, but may be increased through interacting with advertising or other incentives.

Membership levels may only be changed up at the end of a month at the previous level. Generally, a member will start at level one, but may be able to start membership or registration at any membership level. Consecutive month increases to the membership level may be prevented. Consecutive month increases to the membership level may be permitted on certain conditions being met. One or more limits may be included on changes to the level of membership. Monitoring may be included to watch for potentially problematic behaviour by members. A “cooling-off” or time delay period may be included before choosing to upgrade membership level and the level being increased. For example, there may be a wait period of 15, 30 or 45 days before the new level is activated. There are strict time and financial controls on the ability of a person to move up a membership level and so this protects against impulse or addictive behaviours to try to add more funds in order to chase bets or bet further when the maximum spend has already been depleted. The financial control is a key advantage, to the control arrangement to provide a safeguard to the user. The user can bet with confidence through use of the control system, knowing they are within the preapproved spend limit. The incentives and bonuses provided through watching videos and clicking through advertising provides additional betting chances, prizes and discounts, but all without additional spend. The invention provides strong financial confidence to a user, with a limited periodic spend on the gambling entertainment, with the added benefit of increased betting and rewards for interacting with marketing.

The control arrangement includes use a mobile phone app in the usual form, downloaded and registration undertaken. The process can equally well occur on a mobile phone, personal computer or any other suitable electronic device. The verification step is essential however, using identity and financial checks outside of the arrangement. These could be provided in part in person such as at a casino where ID is shown and instant credit check access is available to the host, once the person has been formally identified. The security or verification steps can take any suitable form. Most preferably, a series of external steps including identify verification, credit, employment and financial solvency are conducted as part of the verification process.

The control arrangement preferably provides an access to a user to gambling sites once verified. The gambling sites may not be accessible unless the person has first been registered as a member and verified accordingly. Preferably, the use of the control arrangement provides controlled access to a betting site of only verified users, and control of the spend with a predetermined level.

Preferably, the identification step includes identification of the person to a level similar to that used by financial intuitions. Any suitable identification requirements may be included. A physical visit to an authorised office may be required to show photo ID for example, similar to the bank arrangements. The identification may include any one or more chosen from the following group: full name; age; date of birth; place of birth; nationality; employment status; employment history; benefit claims status; benefit claim history; credit history; financial history and any other suitable checks as deemed necessary.

Preferably, the verification step includes one or more external agency to check the identified person. The checks may be that they are not known as a problem gambler, a bankrupt, that they are financially secure and do not have a criminal record, for example. Preferably, more than one external agency check is conducted. Preferably, a plurality of suitable external agency checks are conducted to verify the status of the identified person.

It is important that the person is identified, and verified as a person allowed to bet, for example being over 18, and not otherwise banned, and financially can afford to do so. Employment or credit checks may be included. Preferably, a plurality of checks and safe guards are included to protect the user from potentially problem gambling. Any suitable verifications checks may be included.

The registration may take any suitable form. Preferably, registration allows a person access to use the app, for the control arrangement. Registration may also include information gathering as to the person's likes, interests and family situation for example. The information gathering may be a separate step. The information gathering may take place at any suitable stage. Preferably, the information gathering is used to tailor advertising to the member. The tailored advertising adds value to the advertiser as they can target the adverts made available to a certain member. The advertisers will pay for the information and access to advertise to this captive audience. The information may relate to family, pets, hobbies and interests for example, profession, sport interests and general tastes. Any suitable information useful to potential advertisers may be gathered in this way. The control arrangement is highly beneficial to the user but is in part funded through the tailored advertising. These adverts allow a company to provide information and discounts to their goods or services to people who are likely to be interested. In return the member increases the value of their bets available and can get rewards, discount and gifts through their membership.

Preferably, a membership card is issued. Preferably, a physical membership card is issued as required to take benefit from some of the rewards, discounts and gifts. An electronic membership card may be included. Preferably, use of the card with partner companies can be for a discount. Over and above the standard discount arrangements afforded to a member, particular other or further discounts and rewards may be given through interaction with the advertisers, through use of the app. Use of the membership card at partner businesses may provide a discount or loyalty bonus. The relationship may work both ways, earning additional points to spend on gambling but also discounts or added benefits at the partner store or business. Any particular discount or benefit with a partner through membership is included and offered to members for particular actions, through use of the app.

The registration may be part of a membership level or tiers registration or this may be separate. Preferably, membership is for a particular membership level. Preferably, membership is for a particular membership level and the membership level dictates the maximum spend for a member. The membership level may also include particular levels of available bonus. The membership level may also include particular levels of available rewards. Preferably, there are a plurality of available membership levels, each with a set, controlled periodic spend whereby the member cannot exceed that predetermined spend.

Preferably, the controlled spend is converted to points or units usable to spend on gambling, and these points can be increased without further financial spend through interacting with advertising.

There may be a system of points or dollars that reflects the real money input plus extra provided through taking particular action. Preferably, the particular action may be chosen from the group: to watch an advert; interact with an advertiser; signing up to something; or making a purchase. The particular action may be to watch an advert. The particular action may be to interact with an advertiser. The interaction with an advertiser may include signing up to something, or making a purchase. The interaction may lead to a bonus to the betting funds available and or physical rewards such as discounts or gifts. The scaling to the actual funds put in to rewards may be different between the membership level. Preferably, the higher the membership level the greater the available rewards and bonus. Preferably, the higher the membership level the greater the available reward points over the funds deposited. Bonuses may be dictated by the membership level as well. The bonus and rewards may be as set out in Table 1, for example.

Preferably, the membership levels can be moved between but only after certain criteria are met. The criteria may include that the entry level membership may need to be held for a period of time before the person can apply to upgrade. Optionally, any suitable membership may be requested at registration. Preferably, upgrade of membership is subject to conditions. Preferably, a repeat of the identification, verification including financial checks are conducted before a person may be approved to upgrade membership. Preferably, membership need be upgraded to enable a larger monetary spend per month or per year. A wait period may be included at any step through the invention to avoid impulse spending or compulsive gambling. Any number of suitable checks may be required to enable moving between membership level. At first a member may be able to register easily and it may be only after some potentially problematic behaviours are observed that stronger tests and financial checks are required. There can be some modification to the identification and verification steps to suit the needs of the management. Where a more significant spend may be allowed, more stringent tests and checks may be necessary.

Preferably, there are 3 or more tiers or levels of membership. There may be 3, 5, 7 or more levels of membership. There may be any number of levels, types or kinds of membership. For example, there may be an annual spend, monthly spend or weekly control arrangement. There may be 10 or more levels of kinds of membership to choose from, as these can offer different controls and rewards to suit the needs of different potential members. Preferably, the rewards and bonus change beneficially as the membership level increases. Preferably, the spend allowed increase with the membership tier. Preferably, the membership tiers reflect to some extent the income of the member. Preferably, the advertising and types of bonus and rewards are tailored to the income of the person. The information gathered during registration can also assist to tailor the advertising to a potential customer.

Financial checks may include checks on income. Income checks may be checked against pre-set levels and only those members with a certain income allowed to proceed to the next membership level. Preferably, the membership level and income are also tied to the tailor advertising, so that the advertisers advertise to potential customers.

Preferably, monitoring is included within the system. Preferably, the monitoring is to watch for potentially problematic gambling behaviours. Rapid increases to the number of bets may be watched for or trying to increase membership levels quickly. Any suitable monitoring may be included.

Accordingly, the invention also provides in a further variant, a method of use of a control application or app for gamblers, the app including:
a registration step to register a potential member for gambling;
a verification step to check the identity of the person;
a financial check step to check the income and or assets of a person;
a gambling value step to set the monetary value that may be gambled for a set period of time, the monetary value being determined by the financial check step to ensure that the person can afford to spend the monetary value on gambling in that set period of time,
   wherein the monetary value provides an upper limit to the gambling in a set time period for the member and an increase to the monetary value spend by the person is only enabled after further financial checks.

The steps may take in any appropriate order. The identification, verification and registration steps would usually take place closely together and can be conducted as a single action. Or the steps may be checked one at a time. Approval may be subject to a wait period.

Accordingly, the invention also provides a control arrangement for an app for gamblers the control arrangement including the following steps:
a) identification of a potential member through data input into the app;
b) verification of the identified user identity;
c) registration as a member of the identified user;
d) application for a membership level based on a financial contribution after a finance and or credit check to ascertain that the identified user is financially able to comfortably spend of the membership level,
   wherein an identified and verified user is able to bet through use of the app only to the financial contribution as denoted by the preapproved membership level.

Accordingly, the invention also provides in a further variant a control application or app for gamblers, the app including:
a registration step to register a potential member for gambling;
a verification step to check the identity of the person;
a financial check step to check the income and or assets of a person;
a gambling value step to set the monetary value that may be gambled for a set period of time, the monetary value being determined by the financial check step to ensure that the person can afford to spend the monetary value on gambling in that set period of time;
   wherein the monetary value provides an upper limit to the gambling in a set time period for the member and an increase to the monetary value spend by the person is only enabled after further checks, and further wherein tailored advertising is included in the app, and the tailored advertising offers and interaction through seeking and pressing a button, to earn bonuses additional gambling funds.

Most preferably, the further checks include a period of monitored gambling behaviour, and a further financial check. There may be flags within the system for particular behaviour which may then cause system messages and alerts. The member may be advised that their account is temporarily suspended for example, if no changes to the behaviour occurs after they are advised.

Most preferably, the control arrangement substantially prevents a person from spending on gambling more money than their income and or assets should allow. Further, careful monitoring of gambling behaviours together with the careful identity registration should act to prevent multiple registrations by the same person, and reregistration of a person once they are identified as a potential problem gambler.

### INDUSTRIAL APPLICABILITY

The invention can be provided through use of electronic devices direct to suppliers and members, for potential mutual benefit. Further, the results of the invention, including membership cards, prizes, vouchers and discount offerings, will be industrially produced and supplied direct to the members, through their recorded address.

### BRIEF DESCRIPTION OF THE DRAWINGS

The invention will now be described in connection with a non-limiting preferred embodiment, with reference to the accompanying drawings, in which:

FIG. 1 is a first example screen shot view of a page from an app according to a preferred embodiment of the invention illustrating the current SBUCKS balance, menu and popup options;

FIG. 2 is a second example screen shot view of a page from an app according to the preferred embodiment of the invention of FIG. 1, illustrating the current SBUCKS balance, how much is available to earn and if a bonus is available;

FIG. 3 is a third example screen shot view of a page from an app according to the preferred embodiment of FIG. 2 illustrating revised SBUCKS balance after watching and advert and earning 100 SBUCKS;

FIG. 4 is a fourth example screen shot view of a page from an app according to the preferred embodiment of the invention of FIG. 3 illustrating revised SBUCKS balance after collecting a bonus of 500 SBUCKS;

FIG. 5 is a fifth example screen shot view of a page from an app according to the preferred embodiment of the invention of FIGS. 1 to 4 illustrating “your teams this week”;

FIG. 6 is a sixth example screen shot view of a page from an app according to the preferred embodiment of the invention of FIGS. 1 to 5 illustrating a particular event, odds and the league table;

FIG. 7 is a seventh example screen shot view of a page from an app according to the preferred embodiment of the invention of FIGS. 1 to 6 illustrating the results of a particular event, odds, and win in SBUCKS;

FIG. 8 is an eighth example screen shot view of a page from an app according to the preferred embodiment of the invention of FIGS. 1 to 7 illustrating two optional screens for a winning bet and for a losing bet (only one will be shown according to the result of a particular bet); and

FIG. 9 is a ninth example screen shot view of a page from an app according to the preferred embodiment of the invention of FIGS. 1 to 8 illustrating SBUCKS rewards for particular retailers that may lead to items such as $5 pizza, buy one get one free offers or discounts from retail outlets;

### DETAILED DESCRIPTION OF THE INVENTION INCLUDING A BEST MODE

We note that words included in the drawings are necessary, and are included to particularly facilitate the understanding of the invention.

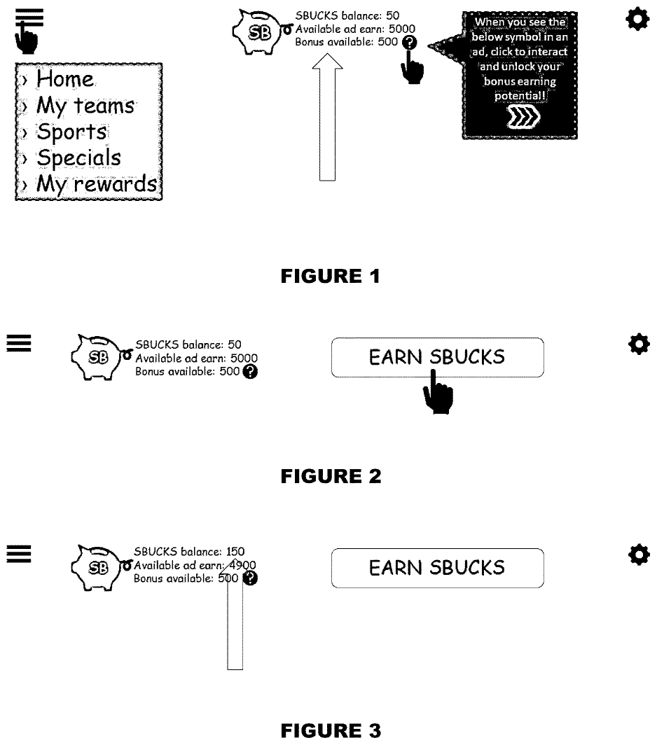

Referring to FIGS. 1 to 9, a preferred embodiment of the invention will be described, together with the table below and general description. A gambling control app will provide access to use of the invention in the given example, linking through to a sophisticated online hosted website or Cloud based hosting with the appropriate security. The invention could be accessed through the website directly, or through a proprietary device, or even through gambling software direct at a casino, for example. However, an app is a useful means to sign up members and it will be through this useful example that the invention will be described.

An important part of the invention is the secure sign up process, it is important that a person is identified and verified as able to use the gambling control app. As is often the way with these apps it may be downloaded for free from the app store or equivalent to enable a potential new member to set up a new customer account; a visit to the website is an alternative means to do so. The information sort for the new customer account will include:—

Create customer account:
1. Basic personal details: name, mobile number, e-mail address, date of birth;
2. Create username and password/pin in the usual manner;
3. Terms and conditions and any other legal or disclosure requirements: Acknowledge warning about risks of gambling, agree not gamble on behalf of minors similar to those used on existing gambling sites;
4. Provide demographic information: occupation, town of residence, gender;
5. Subscription options: monetary value in dollars sought, amount and cycle before new payment, the value will be subject to scrutiny in further steps;
6. Provide financial details: withdrawal of subscription fees and payment of winnings financial institution eg a bank or credit card may be used to automatically deposit the agreed spend, or on activation and the same or different financial institution may be used for deposit of winnings to “cash out”; and
7. Select if they wish to earn rewards—if yes, provide postal details for loyalty card to be sent, as well as promotional materials and discount vouchers, etcetera for the membership.

The initial registration is similar to standard registration but will required correct personal details, such as date of birth, and the financial details, which are not usually asked for on a standard app. Again these will be tested vigorously if the membership proceeds.

Generally, a potential member will be joining to gambling of a few favourite types of betting. It may be that they follow racing and that these favourites may be Australian, Hong Kong and British racing events. Others may like a wide range of sports and will have a few different sports or events as their favourites. The next action on the app, to provide a tailored experience is to Pick some Favourites as follows:

Pick favourite:
Sports
Teams
Players

Following on from the favourites this will store the information as to whether a person is interested in a particular code of football or other events. There may be some tailoring of the ways to earn rewards, bonuses and the types of promotions offered in relation to the answers provided. Following these first questions some more detail is sought:

Answer some questions to personalize experience:

```
What are some of your interests (as many as applicable)
    Outdoor activities
    Gaming
    Fitness
    Food and beverage
    Entertainment
    Travel
What kind of area do you live in?
    Urban
    Rural
What do you prefer to drink?
    Non-alcoholic beverages
    Beer
    Wine
    Spirits
What kind of dining do you prefer?
    Home cooked meals
    Fast food/take-away
    Casual dining
    Fine dining
D you have children? If so, how many?
    No children
    1
    2
    3
    4
    5+
What is their age range?
```

Each of these questions can be used to provide a rounded picture of the potential member for records, for promotions and as part of the identity process. When looking at the financial position to gamble, clearly having more dependents would be an important issue to consider, relative to the income of the person. Again marketing, events and bonuses as well as discount vouchers and tailored advertising videos may be provided suitable for the person and the answers they give to the questions.

The back end database held by the website will store this data (with suitable permissions from the person, and privacy safe guards in place to meet local and international requirements in this regard) as part of the membership process. It is important to try to eliminate duplicate memberships and cross referencing this stored data for shared addresses or other contact details can assist. The person should only be able to provide a single name but further safe guards where variant or diminutives are used are a useful inclusion.

The identify part of the process can be developed to different levels of membership, or as is often used these days, a simple “quick” set up may be used for the initial registration and then further verification and identify steps can be completed to get full or greater access to the app, and the betting functionality. The verification and identification steps can be varied to suit the levels of security and the particular types of membership sought.

The different types of membership available may be defined in any suitable way.

In the following TABLE 1 the membership levels are labelled using bronze, silver etcetera but the particular label is not of great import:

| Member- | | Advertising | |
|---|---|---|---|
| ship | Customer | interaction | Example |
| Tier: | contribution: | bonus: | advertising content: |
| Bronze | $AUD 1-100 | 10% | Fast food |
| | | | Supermarkets |
| | | | Video streaming |
| | | | platforms |
| | | | Apps |
| Silver | $AUD 101- | 12% | Local casual dining |
| | 250 | | Sporting/live events |
| | | | Video streaming |
| | | | platforms |
| | | | Entertainment |
| | | | Gaming |
| Gold | $AUD 251- | 15% | Cars (family/entry |
| | 500 | | level) |
| | | | Local/domestic |
| | | | travel |
| | | | Clothing |
| | | | Experiences |
| Platinum | $AUD 501- | 17% | Luxury cars |
| | 1000 | | International travel |
| | | | Experiences |
| | | | Fine dining |
| Diamond | $AUD 1001+ | 20% | High end cars |
| | | | Investment |
| | | | opportunities |
| | | | Luxury travel |
| | | | Gourmet food and |
| | | | beverage experiences |

$AUD to SBUCKS conversion rate ×10, that is each dollar paid is recorded as 10 times that amount in SBUCKS whereby the SBUCKs can be spent in SBUCKS on gambling within the app for a greater financial value to the actual financial spend value (in part funded by the advertisers-see below)
Advertising interaction bonus based off member contribution
Tier of membership will be reflected in the colour of piggy bank symbol (refer to FIGS. 1 to 9, and when viewed in colour there will be a clear visual indication of the level the person is on, and this will change when the person goes up or down a membership level).

Importantly, there is still a reward and support element that will encourage both the user and the gambling companies to support the use of the app. For the member, a higher level of membership will give a greater percentage available advertising interaction bonus, and a wider range of advertiser promotions and bonuses available. So there is an encouragement, to move up the stages in one sense but actually it can be viewed another way. A person on a high end income is more likely to be influenced by a high end car advertisement and perhaps discount arrangement for purchase than a student say. The tailored advertising enables realistic advertising to a student who may be more interested in value phone plans, and UBER EATS (Trade Mark). A well paid professional may be interested to know about investments, mortgages and of course cars and holidays. Tailored advertising is more likely to be successful and lead to clicks, and so is more desirable for the advertiser. Tracking is included for all of these features to track the success, through clicks or even follow on sales/leads from the advertising. Use of the promotional discount vouchers for example enables resultant sales to be linked back to the app.

Being linked to financial situation gives the advertisers and edge for this tailored advertising, and links through to a realistic spend allowed, including on the gambling. The tailored advertising should mean that not only the bonuses on offer are mostly of interest to be earned but that discount vouchers or potential sales of partner products are also things that the member may well be interested in and can purchase rather than something not likely to be purchased for several years if at all. Simple things like not advertising baby articles to a single person, or cat toys to a dog lover can all be used in targeted marketing, these days.

In setting up the levels and partner businesses and offers, some consideration has been made not only for income but also stage of life, and this can be developed to be a sophisticated marketing tool with rewards that is likely to be very well received by the potential partner customers and dedicated marketers.

Looking at the table in detail the customer contribution can be set for the different levels to have a set contribution, typically monthly. However, the customer contribution could be weekly or an annual contribution for some things, for example an annual footy tipping competition member may wish to cap the annual spend at A$100. Others may link the spend to their income and allow $25, or $50 spend per month, or even A$1000 per year if that is appropriate. That is a lot of money, but data on gambling spending shows that people are often not aware that they may spend A$100s per month, without really being aware that they are spending so much. With existing gambling accounts, they can simply upload more funds from the linked credit card when the account reaches a negative balance, including multiple times in a day, there are very few controls once a person has been allowed an account.

The advertising interaction bonus is set as a percentage of spend and limited as listed to particular advertising content. There may be need to further tailoring, as to the particular person, and there may be a learning element, so that if a person shows interest in a particular advert, then similar adverts can also be shown.

Once the registration for membership has occurred then there will need to be verification of the person, their identity, date of birth, citizenship, employment status and credit rating. Further there will need to be the setup of the credit card or bank accounts and this will need to go through security checks to set this up and the various accounts. Once the member starts their registration, their habits and spend will be monitored and known potentially problematic behaviours will be watched for, and acted upon. These monitoring steps assist to protect the user against potentially problem gambling. Rapid increases in spending may be one clear signal that a problem is developing. When noticed the system will flag the user and contact the user. Messages may be sent to the member if potentially problematic behaviours are detected. Information about problem behaviours may be sent to members. The monitoring may lead to membership being suspended or registration being cancelled.

The registration, identification and verification steps are important, and should determine the level of spend permitted to at least some extent. An employment check may be necessary for example in order that something other than the basic membership level can be obtained. An easy registration option for basic access may also be included. Once registered the new member can log on to the app securely using two level security usually, for example a user ID, password and phone generated pin code for each time the person logs on. The use of the mobile pin enables a location check for the person to make sure they are logging on from the registered geographical region and from the correct phone. Once the registered member has securely logged on they have access to the full functionality of the app, to their registered level.

Referring in particular to FIG. 1 of the attached drawings, a representation of how the screen of the phone using the app would look after login. The first menu of the app for the registered customer is illustrated, as accessed after logging on securely. On the left hand side the menu buttons are listed including: Home; My teams; Sports; Specials; and My Rewards. From the home screen, the user may select any of the options, for example to look at choices for the predetermined favourite teams, to look at particular Sports, see specials available, and to look at My Rewards where bonus opportunities, discount vouchers, gifts and other rewards will be listed. Preferably, the person will be able to get set vouchers, gifts or promotional materials to their registered address on earning the reward and activating these through their account as described in further detail below.

On the right hand upper corner of the screen shot is the typical symbol for settings and the person can make changes to the settings in various menus here. These details include the account and membership, change personal details and preferences and other settings. Information about problem gambling and links to helpful websites are also to be found under the settings button.

The main part of the screen is filled with the piggy bank symbol which is coloured to represent the level of funding the person is registered for or has attained. The clear colour indication of the level of membership is easy to understand if a person has been approved for an upgrade this will be instantly visible. All members may start at bronze level and can then work up over time as their gambling history is approved as not a problem, and their income increases over time. In other forms of the invention starting at any level is possible. As the income increases and the person moves through different life stages then not only does the amount they are permitted to spend increase slightly, but also the advertising is tailored for the different interests and potential sales of the person. The coloured piggy bank is a clear and easy way to show the level of the person within the app., including to other people in a family who may be monitoring a person to see the level of spend.

A question mark symbol is included throughout the app where there is a help information box available, as for this first page. On the help box illustrated is the chevron symbol. The user is encouraged to interact where they see the chevron symbol in advertising to earn a bonus. The bonus could be a gift to be sent to them through post as a reward or free sample, the bonus may be a bonus SBUCKs as described below or they may be discounts or other rewards provided through the advertising interaction. The status of the member is shown in an handy quick method, the colour of the piggy bank, showing the level and also the SBUCK balance, available advertising earn and any bonus available. As shown the person has the following
Customer has subscribed with $AUD 50
This puts them within the bronze tier bracket, reflected by colour of piggy bank being shown as bronze
Customer is given 50 SBUCKS credit as start state (based off their $AUD 50 subscription)
Using the SBUCKS conversion, the available limit of SBUCKS to earn from watching adverts is 5000 SBUCKS for the month
Advert interaction bonus for bronze tier is 10% giving customer 500 SBUCKS available bonus

Referring to FIG. 2, a hand symbol can be seen indicated on the earn buck symbol, and the member selects to earn SBUCKS according to the available calculation for the spend and membership level tier. At this point the balances are shown as the same as in FIG. 1. The person will then be shown on the phone a tailored advert, and rewarded accordingly.

Referring to FIG. 3, the details are as for FIG. 2, but the member has watched a 15 second advert and earned themselves 100 SBUCKS. The increase is automatically added to their account, and automatically deducted from their available earn balance as shown. The balance of SBUCKS can be seen to have increased by the 100 SBUCKS to 150 and the available advert earn has decreased by 100. While many of the adverts will be from partner companies, there will also be government messages and community or public announcement messages as appropriate. As can be seen there are careful limits to the amounts of adverts that may be watched and the points earned.

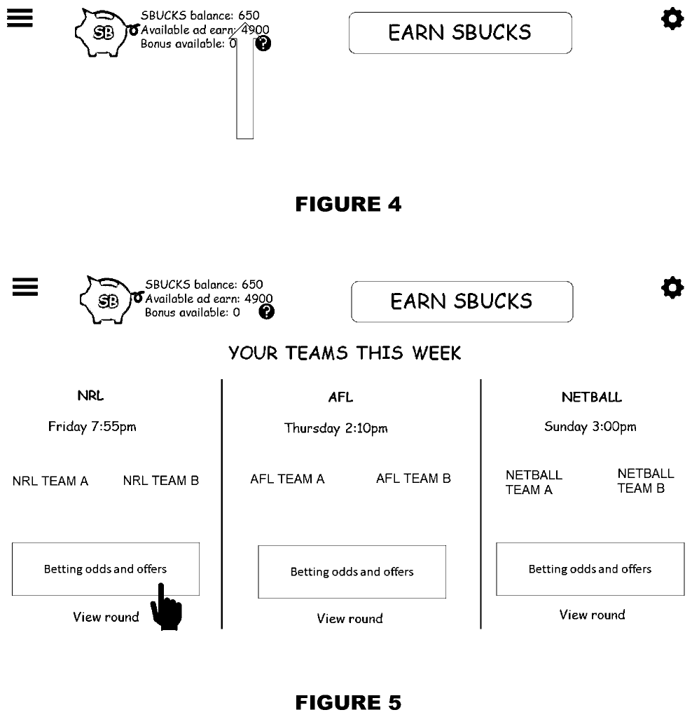

With reference to FIG. 4, the member sees a bonus symbol, the chevron described above, when watching the advert to earn the SBUCKS there is a further option to earn by pressing the bonus button and interacting with the advertiser. It is likely that the advertiser may like to take an e-mail or address or show a further advertisement at this point, or may require a sign up to something, such as a free trial for a movie streaming service, or similar. In return the member may be offered a significant bonus in SBUCKS, as shown a 500 point bonus for signing up to a 7 day free trial of a movie streaming service. The available bonus is shown throughout and then when earned this bonus is removed from the available bonus points and added to the SBUCKs balance as shown. When a further bonus becomes available the bonus available will display to indicate to the user that a further bonus is available to be earned. In addition or instead of there may be rewards available such as a discount voucher for the product, a free sample, a gift with purchase or a gift sent to them, and these may be sent to the registered address of the member, for example.

With reference to FIG. 5, the balances and bonus levels are all shown as in FIG. 4, and the Your Teams menu item has been selected instead. These teams may be varied for different countries and different favoured sports. For example, in Australia the favourite teams chosen may be for three favoured sports, NRL, AFL and Netball with the followed favourite teams selected accordingly. More or less sports can be followed and different setups allowed. There may also be differences in for the different levels of membership is some forms of the invention.

Under each sport and the two teams playing where there may be a gambling opportunity of interest there is included a button Betting Odds and offers. The app will be linked to all the major gambling betting houses is some forms, or just a single betting organisation. In either case the odds, or chose of odds and bets available for each sport can be viewed by pressing these buttons in turn. Where there are multiples sports of interest these may all be viewed for betting opportunities. Below the betting odds option the entire round of sport can be viewed instead and other teams or options selected.

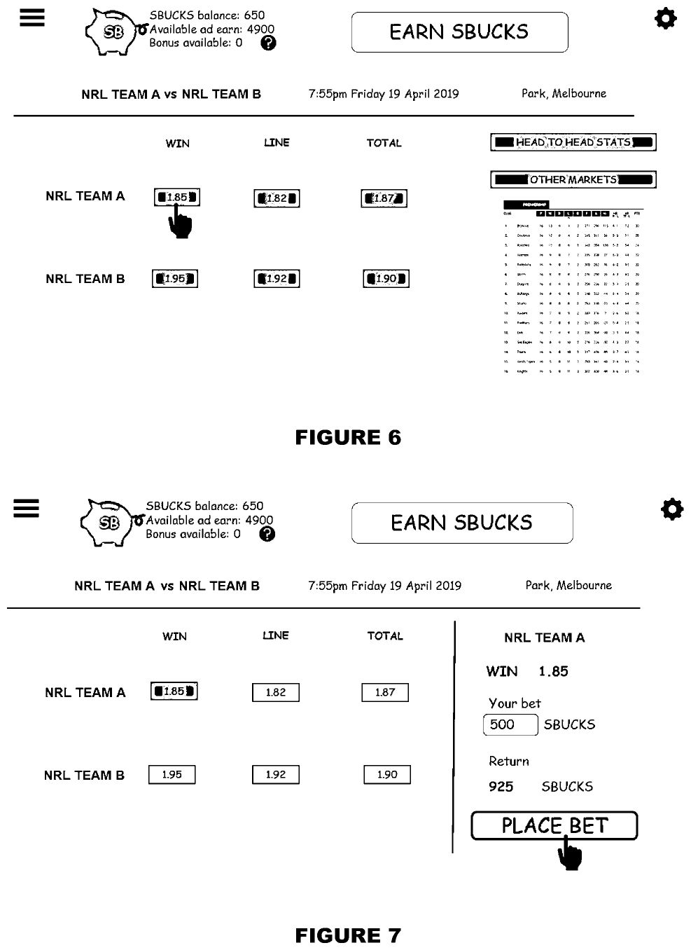

With reference to FIG. 6 the round details are shown including the venue of the event, and the league table and options such as statistics and other markets. Again these can be varied to suit the particular partners or set up who use the app. Below the particular teams and the betting options are offered, and as shown for a team to win or line betting. Any known form of betting, for any sport, or any existing betting system or company can be used with the app to provide a control and safety for the member and advertising advantages. The example here is for illustrative purposes only, and it can be seen that the different sports, types of betting and different betting companies could all be used with the invention.

With reference to FIG. 7, the bet can finally be placed, not using money but using SBUCKs including the financial contribution and any bonus. As shown the value to be bet on a particular team is entered. The potential win in SBUCKS is shown and the option to place and confirm bet is given.

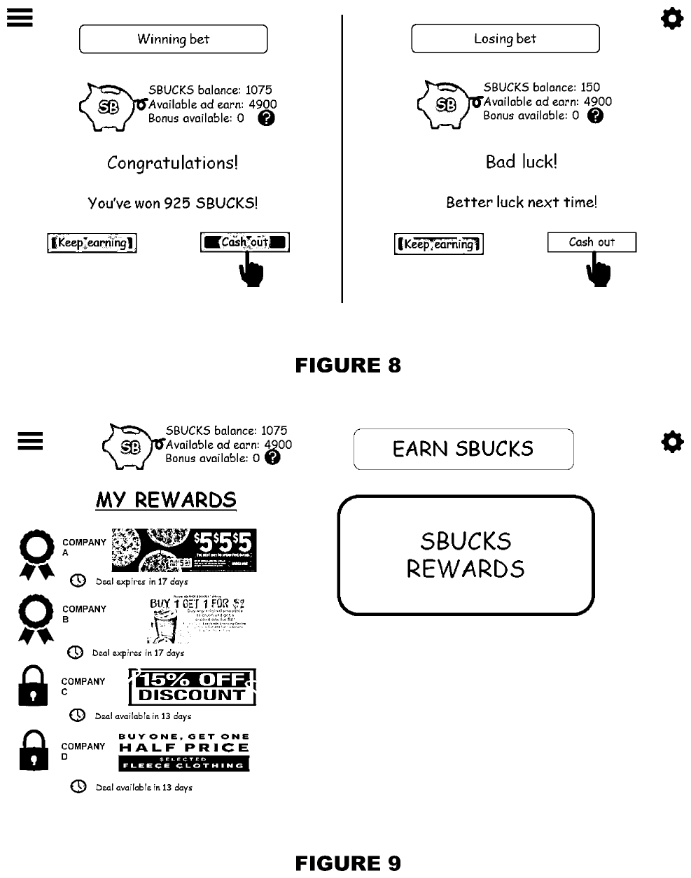

With reference to FIG. 8 after the sporting event the member will be alerted to a win or a lose, both options are shown in a single screen here for ease of illustration but only one of these would show to the member as appropriate. Where a winning bet has been placed the increased SBUCKs balance is shown, together with the available ad earn and bonus as usual. On this option a “Congratulations” message is sent and the value of the win displayed with two options, “keep earning” or “cash out”. Where a person selects cash out as shown by moving the hand symbol over the button they will be taken to another page to confirm and authorise the payment into the financial institution. It is anticipated that other than for a very big win most gamblers will keep the funds in the app to allow for more scope for the entertainment of gambling, as additional funds cannot be readily added as in other gambling apps. A member can cash out all or some of the available funds, within the predetermined limits of the app.

On the losing bet screen the information shows that there has been no increase to SBUCKs and the cash out button is not highlighted indicating that this is not available at this time.

Referring to FIG. 9 the SBUCKS rewards are shown with various options available. The greatest variety will be offered through the rewards which can be real things sent through the post, discounts on products, even on a new car or holiday, or bonus service or products. In the most part these will be discounts and offers from tailored partner companies to induce members to use or buy particular products. The rewards are linked with the membership card issued to all members once the vigorous verification process, including financial and credit checks have been traversed. The illustrated rewards may offer a choice of one or more options that may be available to a particular member. For example, cheap pizza, buy one get one free juice, 15 percent savings off a food delivery company, or half price products from a sports company. There will be a wide choice and some of these may be available to all members, others may be available to a member who has stayed for a time period, and or through use of the app gained bonuses. As can be seen some of the My Rewards are available (the top two with the rosette symbol, and the expiry date) and the bottom two are locked. These have notes in this example that the deals are available in 13 days. Some rewards will simply be controlled by time, some others will require particular action to claim. For example, a free t-shirt or hat may be on offer for a participant in a football tipping completion if the member participates from start to finish. There are a great many forms the rewards can take, not limited to vouchers, as would be understood. For example the customer rewards are offered based on the following:
Quantity of rewards based on months of membership
Quality of rewards based on membership tier

Customers redeem rewards by clicking the coupon banner and presenting their loyalty card at time of transaction. During sign up, if the customer chose not to receive a loyalty card they are ineligible for the rewards.

Overall, the invention enables far better verification and control of gambling for a member to be controlled within their income, and through partners, advertising and rewards the gambler can earn SBUCKS to increase their spend without actually adding any further funds. The advertisers benefit from the information and tailored advertising and incentivised marketing opportunities. The member benefits by free bets through additional SBUCKS and discount vouchers and other rewards as part of membership. The financial controls and monitoring can assist to look out for the wellbeing of members and for early identification and intervention of potential problem gamblers before there is a risk of a big spend they can ill afford. The app is for everyone as it provides a fun way to get more SBUCKS to spend, with that safety net so a person can know they will not be able to spend more on betting each month that they intend. Often a person will be unaware that they may spend more than they should say through football season but through use of the app they can know if there are SBUCKS available they can enjoy a bet guilt free. If no SBUCKS are available there is no way to top this up, not until membership levels are up for review. There can be time restrictions so that a level of membership may only be increased after a time period of sensible betting, again to protect the member. The app gives safe guards for the users, and supports the gambling industry by removing some of the risks and provides additional funding through highly tailored marketing. Advertising online is a significant part of advertising and is highly successful in leading to sales of fast food, clothes, shoes, apps and other products. As the invention uses consumer interaction through bonuses as well as the more traditional passive advert watching, the response is likely to be much stronger with strong results for the advertiser. Of course the member has the benefit through the bonus SBUCKS and potential rewards through use of the membership or loyalty card. The tailored adverts should be products and discounts of interest so there should be benefit all around.

The invention is likely to be well received by the general community as a good way to control gambling, in a fun and rewarding manner.

It will be apparent to a person skilled in the art that changes may be made to the embodiment disclosed herein without departing from the spirit and scope of the invention in its various aspects.

1-57. (canceled)

58. A control arrangement for an application “app” for gamblers, the control arrangement including the following steps:
a) identification of a potential member through data input into the app;
b) verification of an identified user identity, and the verification including a series of steps, including external verification steps by links to one or more external database to verify the identity, credit and or financial information about the user, and the information includes at least one of; age; date of birth; address; nationality; employment status; employment history; benefit claim status; benefit history; marital status; whether they have dependents; credit check; debt or other checks outside of the credit check; accounts with gambling institutions; verification of payment; and verification of ownership of payment means;
c) registration as a member of an identified and verified user of steps a) and b), the registration including information gathering of information that can be used to direct advertising to the member; and
d) application for a membership level,
wherein the membership level limits a periodic spend, and a verified member can gain membership rewards and or betting rewards, including through interaction with the advertising, and further wherein there is no mechanism to increase funds available for betting, outside of upgrading the membership level.

59. The control arrangement of claim 21, wherein a previously identified problem gambler is flagged on the system by the verification step, and registration will not be permitted, to protect the gambler from further gambling.

60. The control arrangement of claim 21, wherein a time delay is incorporated into the verification step, to enable time for intervention action for potentially problem gamblers.

61. The control arrangement of claim 21, wherein the membership level limits the periodic spend to a set spend for the member, and the membership level and spend cannot be increased without meeting certain conditions.

62. The control arrangement of claim 21, wherein checks on income and their gambling history can be used, to only permit a person to gamble if they do not have a history of problem gambling.

63. The control arrangement of claim 21, wherein use of the control app provides a safe guard to a member to limit the spend per month or per year on gambling to a certain figure.

64. The control arrangement of claim 21, wherein the amount of spend dictates a number of points, and the points can be spent on gambling, but may be increased only through interacting with advertising or other incentives.

65. The control arrangement of claim 21, wherein one or more limits may be included on changes to the level of membership.

66. The control arrangement of claim 21, wherein monitoring is included to watch for potentially problematic behaviour by members.

67. The control arrangement of claim 21, wherein there are time and financial controls on the ability of a person to move up a membership level and so this protects against impulse or additive behaviours to try to add more funds in order to chase bets or bet further when the maximum spend has already been depleted.

68. The control arrangement of claim 21, wherein a membership card is issued including a physical membership card as may be required to take benefit from some of the rewards, discounts and gifts, with partner companies for a discount.

69. The control arrangement of claim 21, wherein over and above the standard discount arrangements afforded to a member, particular other or further discounts and rewards may be given through interaction with the advertisers, through use of the app.

70. The control arrangement of claim 21, wherein membership is for a particular membership level and the membership level dictates the maximum spend for a member.

71. The control arrangement of claim 21, wherein the membership level also includes particular levels of available bonus and the membership level also include particular levels of available rewards.

72. The control arrangement of claim 21, wherein the controlled spend is converted to points or units usable to spend on gambling, and these points can be increased without further financial spend through interacting with advertising.

73. The control arrangement of claim 35, wherein particular action interaction may lead to a bonus to the betting funds available and or physical rewards such as discounts or gifts.

74. The control arrangement of claim 21, wherein the higher the membership level the greater the available rewards and bonus.

75. The control arrangement of claim 21, wherein the membership levels can be moved between but only after certain criteria are met.

76. The control arrangement of claim 21, wherein a repeat of the identification, verification including financial checks are conducted before a person may be approved to upgrade membership.

77. A method of use of the control application or app for gamblers, the method including:
a) a registration step to register a potential member for gambling;
b) a verification step to check the identity of the person;
c) a financial check step to check the income and or assets of a person;
d) a gambling value step to set the monetary value that may be gambled for a set period of time, the monetary value being determined by the financial check step to ensure that the person can afford to spend the monetary value on gambling in that set period of time,
wherein the monetary value provides an upper limit to the gambling in a set time period for the member and an increase to the monetary value spend by the person is only enabled after further financial checks.
